(19) United States
(12) Patent Application Publication
(10) Pub. No.: US 2007/0156846 A1
(43) Pub. Date: Jul. 5, 2007

(54) Method of enabling a wireless information device to access customer support services

(75) Inventor: Richard Seward, London (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: Intuwave Limited, Berkshire (GB)

(21) Appl. No.: 10/575,069

(22) PCT Filed: Oct. 8, 2004
(86) PCT No.: PCT/GB04/04287

§ 371 Date: Feb. 23, 2007

(30) Foreign Application Priority Data
Oct. 8, 2003 (GB) 0323549.6

(51) Int. Cl. G06F 15/16

(52) U.S. Cl. 709/219

(57) ABSTRACT

If an end-user of a wireless information device has a support requirement, he opens a data connection from his device to a customer support computer; the data connection remains open whilst the device progresses up a queue of an automated queuing system connected to the customer support computer. A predefined action is initiated that meets the support requirement before the device reaches the top of the queue or when the device reaches the top of the queue.

### BACKGROUND OF THE INVENTION

1. Field of the Invention

This invention relates to a method of enabling a wireless information device to access customer support services. The term ‘wireless information device’ used in this patent specification should be expansively construed to cover any kind of device with two way wireless information capabilities and includes without limitation radio telephones, mobile telephones, PDAs, smart phones, personal computers, and application specific devices. It includes devices able to communicate in any manner over any kind of network, such as GSM, GPRS, UMTS, CDMA and WCDMA mobile radio, Bluetooth, IrDA etc. as well as any such device when connecting to customer support services via a wire based system, such as via a cradle connected to a PC, the PC being connected to the internet. A customer support service is any kind of service offered to an end-user of a wireless information device that helps the end-user fully or properly take advantage of a product or service that is designed to be used by the end-user. It therefore covers help systems from wireless service providers as well as any other kind of customer service function (e.g. call centres, enquiries, sales etc) provided by another organisation, such as a bank, games developer, IT help desk of the end-users' employer etc.

2. Description of the Prior Art

End-users of wireless information devices frequently need to speak with customer support services; these services usually operate an automated voice call queuing system. But it can be very inconvenient having to stay on-hold whilst your call progresses up the queue, particularly if the end-user has to hold the device up to his ear during that time.

For providers of customer support services (such as wireless operators, enterprises, application vendors and service providers etc.) it is very important that end-users have a good customer support experience; however, that can be a challenge given the fact that end-users will often need to be placed into an automated queuing system, with the inherent danger of being placed on-hold for excessive time.

In the Internet world, this problem is partly addressed through web call-back systems: these involve a small ‘call me’ icon on a web site; when a user selects this icon, a prompt comes up, requesting that the end-user types in his name, contact number and a convenient time to call. The information is provided to a customer service operator, who makes the voice call at the designated time. Web call-backs can be useful in situations where customers would rather deal with a person rather than navigate possibly complex web pages. One problem with these systems is that end-users often cannot reliably schedule a call for later on in the day; ideally, the end-user would often like to be called back immediately by a real person, but that is rarely possible.

### SUMMARY OF THE INVENTION

The invention is a method of enabling a wireless information device operated by an end-user to access customer support services, the end-user having a support requirement, comprising the steps of:
(a) opening a data connection between the device and a customer support computer;
(b) keeping the data connection open whilst the device progresses up a queue of an automated queuing system connected to the customer support computer;
(c) initiating a predefined action that meets the support requirement before the device reaches the top of the queue or when the device reaches the top of the queue.

The predefined action meets the support requirement (i.e. is meant to address some or all of the support requirement) and hence includes:
(a) a customer service representative (‘CSR’) calling the end-user back (i.e. making a voice call to the end-user); this will generally only occur when the device reaches the top of the queue, although it is possible for the CSR to decide to call an end-user back earlier than that in certain cases (e.g. predefined types of very urgent support requirements or special categories of end-users);
(b) causing data to be downloaded from the device;
(c) causing data or an application to be written to the device.

The CSR may call back the end-user for a number of reasons, including to inform the end-user that the support request has been completed, to better understand the nature of the support requirement and to discuss how to fulfil the support requirement. Further, progress through the queue may be governed not only by time spent in the queue, but also by a number of factors determined by the customer support service provider, these may include for example: customer value, priority of the support requirement (whether measured in time lost, financial value, business impact or other metrics) and risk of customer ‘churn’ i.e. defection to another service provider.

The support requirement could be a request or query to be put to the CSR by the end-user, or a request for a specific service (e.g. back-up, synchronisation, install application updates and patches etc.). The end-user defines the support requirement using a conventional user interaction (e.g. selection from device menus, dialog boxes, free text entry, speech input etc.). The definition may be as simple as requesting, that a CSR call back, or may involve the end-user typing into the device a detailed free text description of a problem and what he wishes to do and sending that to the customer support computer. In any event, this information is then sent to the customer support computer (which is typically a server). It is this process that initiates the dialogue with the customer support computer and any CSR—there is no need to commence with a voice call to a CSR and to stay on hold until a CSR becomes available.

This approach therefore avoids the need for the end-user to simply wait in a queuing system for a CSR to answer a voice call. But, because there is a data connection open whilst the device progresses up the queue, it is possible for useful data to be transferred from and to the device during this time, as well as when the device actually reaches the top of the queue. This data can assist the customer service representative in efficiently meeting the support requirement.

As noted above, data/applications can flow to the device to meet the support requirement; for example, this may be to fix a problem, update software (e.g. OS patches; other updates), upload new software, or synchronise data on the device with an external data set. This data flow can happen when the device reaches the top of the queue, either automatically or when a CSR initiates the data flow. In addition, this data can also flow to the device over the data connection prior to the device reaching the top of the queue; other kinds of data may also flow to the device prior to the device reaching the top of the queue, such as data indicating the queue position and/or likely time before a customer service representative will initiate the predefined action. There may also be a visual indication on the device that the data connection is open and/or the position in the queue.

The device may be automatically queried by the customer support computer to obtain information relevant to the support requirement. The information may for example include one or more of the following kinds of information:
(a) Any or all of device's phone number, International Mobile Equipment Identifier (IMEI) or International Mobile Subscriber Identifier (IMSI);
(b) recent key strokes;
(c) recent remote web or WAP sites visited by the device;
(d) current state of the device, including Operating System, application/configuration settings, installed applications, battery status, memory status, dropped calls;
(e) end-user's name;
(f) end-user's address;
(g) end-user's bank, credit and/or charge card details;
(h) end-user's password;
(i) goods and/or services recently requested or acquired by the end-user using the device;
(j) device usage profile or data;
(k) device geographic location data;
(l) device error logs;
(m) identification of all programs/processes running on the device;
(n) device data to be backed-up or replicated.

This querying can happen when the device reaches the top of the queue, either automatically or when a CSR initiates the querying; in addition, it can happen prior to that so that the CSR already has this information when the device reaches the top of the queue. The device may display a user prompt requiring the end-user to consent to specifically requested kinds of information being sent to the customer support computer. The user prompt requires the end-user to satisfy an access control process before releasing the information to the computer.

If the CSR calls the end-user back, then the data connection may remain active after the voice call has been started to enable the CSR to continue to obtain data from the device and/or write data to the device of a kind that will assist the CSR to meet the support requirement.

Hence, with the present invention, when an end-user customer of some service (e.g. a customer of the mobile network itself, or a customer of any other kind of product or service) wishes to contact the relevant customer service department, rather than calling and waiting on hold for a customer service representative to become available, they use a software program on the Wireless Information Device to indicate their wish to be supported (e.g. contacted) by the appropriate customer service department. Alternatively the user of the Wireless Information Device can make a voice call into customer services, and customer service's call response centre, upon confirming their wish to initiate a customer support session, will verify that the appropriate software exists on the Wireless Information Device, and cause a connection to be initiated between the Wireless Information Device software and the customer support server.

The third option is that customer services pre-emptively (i.e. without explicit notification by the-end-user) determines that the end-user requires support and causes the data connection to be initiated between the Wireless Information Device software and the customer support server. This final option clearly requires prior agreement between the end-user and customer services over how it will be exercised. In this third option, determination that the end user has a support requirement may be made through a number of ways:
A problem is identified with a component of the end-user's service on the device, for example the device model, OS version, or application version, or indeed a particular combination of these. Customer services review their customer base and identify the end user as having this component, or particular combination of components, that require corrective action. This problem may have been identified from a number of sources, including the vendor of the component or even the pattern of support calls from other end users.
A problem is detected by customer services in the end-user's use of a particular service. This may be indicated by, for example, above-average rate of dropped calls, shorter-than-average battery life, or failed application transactions. The problem may be due to, for example, the wireless information device itself, or the knowledge and skill of the end user.

In either of the three cases, the software on the Wireless Information Device, in conjunction with the customer services computer software, through some kind of data connection, acknowledges that the end-user has made a request for support, and through some kind of querying process places enough information about the customer and possibly the nature of their support request and current situation onto a queue so that the relevant customer services representative will be able to provide the required support (e.g. contact the user etc.) as soon as the required customer support resources become available. The querying process may involve the interactive navigation of a menu, which may provide the user with enough information or services to allow the customer to solve the problem themselves.

The now-established data connection from the customer's Wireless Information Device to the customer services (e.g. a server) remains active, and allows for information such as estimated time remaining in queue to be shown to the customer. If the customer chooses to remain on the waiting queue, a customer services representative who becomes available may have the ability to use the already established connection to query the Wireless Information Device and the customer for more information to solve the problem.

The CSR may choose to call the end-user back: in current 2.5 G handsets using GSM and GPRS, and also in later mobile data/voice networks, the data connection can remain active (or at least only suspended) during this conversation, allowing the customer support representative to further query the Wireless Information Device and customer for information.

The chief advantage of this invention is that the user has to spend less perceived time waiting on hold for customer service representatives, thus increasing customer satisfaction. In particular, the end-user does not have to dedicate their time to actively waiting on hold. Instead, he is involved only when a CSR is available, or potentially even when a CSR has already investigated and addressed successfully the support requirement (e.g. fixed the end-user's problem). As well, a connection between Wireless Information Device and customer services is established and ready when a customer services representative becomes available, which would allow for the representative to programmatically query the phone for much needed information without requiring the customer to answer a barrage of questions.

In another aspect, there is a wireless information device operated by an end-user, the device being programmed with software that enables the device to:
(a) open a data connection between the device and a customer support computer;
(b) keep the data connection open whilst the device progresses up a queue of an automated queuing system connected to the customer support computer;
(c) allowing a predefined action that meets the support requirement before the device reaches the top of the queue or when the device reaches the top of the queue.

Allowing the predefined action may include one or more of the following:
(a) accepting a voice call from a customer service representative;
(b) allowing data to be downloaded from the device;
(c) allowing data or an application to be written to the device.

### DETAILED DESCRIPTION

In an implementation of the present invention, a software program on a Wireless Information Device is capable of some form of electronic data access, and a corresponding customer support computer (i.e. server) is accessible for data access to the Wireless Information Device.

The server address is either contained in the Wireless Information Device software, or else determined though reference to another server performing the role of directory server.

When an end-user of some service (e.g. a customer of the mobile network itself, or a customer of any other kind of product or service) wishes to contact the relevant customer service department, rather than calling and waiting on hold for a customer service representative to become available, they use the software program on their Wireless Information Device to indicate their wish for service from the appropriate customer service department.

The following events then take place (variations are described later):
1. The software on the Wireless Information Device prompts the end-user to describe the nature of their request, using a mixture of User Interface approaches that might include for example menus, multiple choice questions or free-text entry. The querying process may involve the interactive navigation of a menu, which may itself provide the end-user with enough information or services to allow the customer to solve the problem themselves.
2. The software on the Wireless Information Device queries its host device for further information relevant to the request, for example battery status, and also information to identify the end user and/or device, for example one or all of device's phone number, International Mobile Equipment Identifier (IMEI) or International Mobile Subscriber Identifier (IMSI). This may require that the software program is able to execute with sufficient permissions under the Wireless Information Device operating system's security model to obtain the relevant information.
3. The software on the Wireless Information Device establishes a network connection to the server, passing the information gained in steps 1 and 2 above. It is important to note that some token identifying the end user or device will be passed in the process of establishing this connection, most probably one or all of device's phone-number, International Mobile Equipment Identifier (IMEI) or International Mobile Subscriber Identifier (IMSI). The connection may be established over one of a number of network options, including GPRS, UMTS, GSM data call or via a combination of the device cradle's data connection to a PC and the PC's own network connection. The connection may use a range of protocols and data formats. These may be customised for reasons of performance, or they may follow industry standards, including, but not limited to, HTTP or OMA DM. If required, authentication of either, or indeed both, parties to one another will take place at this stage.
4. The server updates the Wireless Information Device with queue position and/or estimated waiting time information. It may need to make reference to other servers holding customer information to derive this information (for example, customer value, which might be held in a separate Customer Relationship Management system). This will be displayed on the Wireless Information Device's User Interface and/or indicated audibly.
5. The Wireless Information Device is taken off the queue when its support call is accepted by a CSR for processing. Note that the CSR may use additional factors besides waiting time in selecting which Wireless Information Device to process, for example customer value. Again, this event will be notified to the end-user on the Wireless Information Device.
6. The CSR processes the support call, potentially using the already-established data connection to further query the Wireless Information Device and the customer for more information to solve the problem. Actions requiring user attention, for example answering a question, will be brought to the end-user's notice via visual and/or audio cues.
7. Depending upon both the nature of the problem and of the relationship between the end-user and the service provider, the CSR may use the data connection to interact with the Wireless Information Device. This may be required to:
   a. Better understand the nature of the end-user's problem.
   b. Apply fixes to the Wireless Information Device.
   c. Test and verify the fix.
8. The CSR may place a voice call back to the end-user as part of processing the call (for example, to clarify a difficult issue), or to conclude the support call (for example to inform the end-user that the problem has now been fixed). This may leverage the fact that certain Wireless Information Devices and data connections allow data connections to be suspended (e.g. GPRS), or even remain active (UMTS) during a voice call.
   Variations Exist:
Variation A to step 1. The software on the Wireless Information Device may be configured to attempt to guide the end-user through problem resolution, and only offer the option to place a call onto a queue once other options have been exhausted
Variation B to step 1. The menu structure and options may be obtained dynamically from the server (or at least updated) in which case a data connection will be established at this stage.
Variation C to step 1. The end-user does not initiate the process, instead customer services preemptively determines that the customer requires support and cause the connection to be initiated between the Wireless Information Device software and the customer support server. Determination that the end-user has a support requirement may be made through a number of ways:
   A problem is identified with a component of the end-user's service on the device, for example the device model, OS version, or application version, or indeed a particular combination of these. Customer services reviews their customer base and identifies the end-user as having this component, or particular combination of components, that require corrective action. This problem may have been identified from a number of sources, including the vendor of the component or even the pattern of support calls from other end-users.
   A problem is detected (e.g. by customer services) in the end-user's use of a particular service. This may be indicated by, for example, above-average rate of dropped calls, shorter-than-average battery life, or failed application transactions. The problem may be due to, for example, the wireless information device itself, or the knowledge and skill of the end user.
Variation to step 5. The CSR may view the list of queued calls and select a call based on their own judgement, or they may be sent a call to process based on a set of prioritisation rules encoded at the server, or another computer at the service provider.

The chief advantage of this invention is that the end-user does not have to dedicate their time to actively waiting on hold. Instead, they are involved only when a CSR is available, or potentially only when a CSR has already investigated and fixed their problem.

As well, a connection between the Wireless Information Device and customer services is established and ready when a customer services representative becomes available, which would allow for the CSR to programmatically query the phone for much needed information without requiring the customer to answer a barrage of questions.

1. A method of enabling a wireless information device operated by an end-user to access customer support services, the end-user having a support requirement, comprising the steps of:
(a) opening a data connection between the device and a customer support computer;
(b) keeping the data connection open whilst the device progresses up a queue of an automated queuing system connected to the customer support computer;
(c) initiating a predefined action before the device reaches the top of the queue or when the device reaches the top of the queue.

2. The method of claim 1 in which the predefined action includes one or more of the following:
(a) a customer service representative (‘CSR’) calling the end-user back with a voice call;
(b) causing data to be downloaded from the device;
(c) causing data or an application to be written to the device.

3. The method of claim 1, in which the data connection is opened in response to input from the end-user, the input being a response to an on-screen dialog, prompt, free-text input, menu selection or icon, or speech input, that defines the support requirement.

4. The method of claim 1 in which the data connection remains active to enable the customer support computer to download data from the device or write data or applications to the device before the device reaches the top of the queue.

5. The method of claim 1 in which the device receives (and optionally displays) data sent over the data connection from the customer support computer which indicates the queue position and/or likely time before a customer service representative will respond in person to the end-user by initiating a voice call or accessing the Wireless Information Device.

6. The method of claim 1 in which the device displays a visual indication that the data connection is open.

7. The method of claim 1 in which the device displays a visual indication of the queue position.

8. The method of claim 1 in which the device is automatically queried by the customer support computer either before or when the device reaches the top of the queue to obtain information relevant to the end-users support requirement.

9. The method of claim 1 in which the device automatically sends information relevant to the end-users support requirement with an initial connection message.

10. The method of claim 8 in which the information includes one or more of the following kinds of information:
(a) Any or all of device's phone number, International Mobile Equipment Identifier (IMEI) or International Mobile Subscriber Identifier (IMSI);
(b) recent key strokes;
(c) recent remote web or WAP sites visited by the device;
(d) current state of the device, including operating system, application/configuration settings, applications, battery status, memory status, dropped calls;
(e) end-user's name;
(f) end-user's address;
(g) end-user's bank, credit and/or charge card details;
(h) end-user's password;
(i) goods and/or services recently requested or acquired by the end-user using the device;
(j) device usage profile or data;
(k) device geographic location data;
(l) device error logs;
(m) identification of all programs running on the device;
(n) device data to be backed-up or replicated.

11. The method of claim 10 in which the device displays a user prompt requiring the end-user to consent to specifically requested kinds of information being sent to the customer support computer.

12. The method of claim 11 in which the end-user prompt requires the end-user to satisfy an access control process before releasing the information to the customer support computer.

13. The method of claim 2 in which the CSR calls the end-user for one of the following reasons: to inform the end-user that the support request has been completed, to better understand the nature of the support requirement and to discuss how to fulfil the support requirement.

14. The method of claim 1 in which it is determined, without explicit notification by the end-user, that the end-user requires support and the data connection is then opened.

15. The method of claim 14 in which it is determined that the end-user has a support requirement when a problem is identified with a component of the end-user's service on the device.

16. The method of claim 14 in which it is determined that the end-user has a support requirement when a problem is detected in the end-user's use of a particular service.

17. The method of claim 16 in which the problem is indicated by one or more of the following: above-average rate of dropped calls, shorter-than-average battery life, or failed application transactions.

18. A wireless information device operated by an end-user, the device being programmed with software that enables the device to:
(a) open a data connection between the device and a customer support computer;
(b) keep the data connection open whilst the device progresses up a queue of an automated queuing system connected to the customer support computer;
(c) allow a predefined action that meets the support requirement before the device reaches the top of the queue or when the device reaches the top of the queue.

19. The device of claim 18 in which allowing the predefined action includes one or more of the following:
(a) accepting a voice call from a customer service representative;
(b) allowing data to be downloaded from the device;
(c) allowing data or an application to be written to the device.
